(19) United States
(12) Patent Application Publication
(10) Pub. No.: US 2009/0238413 A1
(43) Pub. Date: Sep. 24, 2009

(54) METHOD FOR QUANTIFYING METAL COLLOID

(76) Inventors: Naru IKEDA, Tokyo (JP); Hiroshi Kubota, Kawasaki-shi (JP); Yuki Kudo, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/388,820

(22) Filed: Feb. 19, 2009

(30) Foreign Application Priority Data
Mar. 19, 2008 (JP) 2008-071575

(51) Int. Cl. G06K 9/00; B05D 1/00

(52) U.S. Cl. 382/109; 427/8

(57) ABSTRACT

A method for quantifying metal colloidal particles carrying to-be-detected analytes, includes producing an inspection sample by developing solution containing the metal colloidal particles on a substrate, generating a plurality of image data about an identical visual field by enlarging and capturing the sample, removing a signal component derived from an impurity existing on the substrate from the image data by comparing the plurality of image data, and measuring the metal colloidal particles from the image data from which the signal component derived from the impurity was removed.

### CROSS-REFERENCE TO RELATED APPLICATIONS

This application is based upon and claims the benefit of priority from prior Japanese Patent Application No. 2008-071575, filed Mar. 19, 2008, the entire contents of which are incorporated herein by reference.

### BACKGROUND OF THE INVENTION

1. Field of the Invention

The present invention relates to a method for detecting specific trace substances such as biologically-relevant molecules or environmental impact materials selectively and in high-sensitivity, in more detail, a method for coupling such an infinitesimal quantity of materials with metal colloidal particles selectively and detecting trace substances using a local plasmon resonance scattering phenomenon of metal colloid when irradiating light.

2. Description of the Related Art

It is known that early detection of fatal disease such as malignant tumors improves a treatment effect. In order for the fatal disease to a human body to be discovered early, it is necessary to detect materials peculiar to the disease, for example, cancer markers at the stage that only an infinitesimal quantity of materials are released at the beginning of disease contraction. Such specific trace substances are included in a specimen sample, for example, blood. However, the quantity of specific trace substances is as extremely small as 1 pg/ml order or less at the beginning of disease contraction. Further, this specimen sample contains materials derived from the living organisms such as various protein or lipid. Such materials obstruct detection of the specific trace substances. Accordingly, a method capable of detecting the substances of 1 pg/ml or less selectively in high-sensitivity as well as an appropriate separating measure for removing impurities are necessary for the specific trace substances to be detected.

(Detection of Specific Trace Substances Using an Optically Active Probe)

In order for such specific trace substances to be detected, an optical detection method is effective which includes the steps of coupling the trace substances to optically active probe materials selectively using immunologic reaction, and measuring fluorescence or absorption/reflection property or scattered light by irradiating light to the specimen. Conventionally a surface plasmon resonance sensor or a local plasmon resonance sensor uses such an optically active probe. The local plasmon resonance sensor uses typically a sensor wherein metal fine particles are fixedly-formed on a substrate such as a glass in the shape of film, as shown in JP-A 2000-356587 (KOKAI), and is configured to quantify the trace substances in the specimen solution by dipping this sensor in the specimen solution including the trace substances to be detected, coupling the metal fine particles with the trace substances, and measuring an optical transmittance or optical reflectance of the sensor before and after coupling. In order for the trace substances to be quantified to couple with the metal fine particles selectively, the metal fine particles are modified previously with a material to specifically couple with trace substances such as antibodies.

When a content of specific trace substances in a specimen sample or the density is extremely low, measurement of bulk quantity such as absorbance of the specimen sample or fluorescence intensity thereof deteriorates an amount of change of a signal and a SN ratio, resulting in complicating acquirement of a significant measurement result. In the case of the local plasmon resonance sensor wherein metal fine particles are fixed on a glass substrate in a form of film as shown in JP-A 2000-356587 (KOKAI), if a ratio of the specific trace substances to the whole film of metal fine particles coupled to the specific trace substances decreases, change of a measurement amount relating to the whole metal fine particles such as an optical transmittance of the sensor or a reflectance ratio thereof decreases, resulting in complicating detection of the specific trace substance. Alternatively, there is a method of reacting specific trace substances to metal fine particles, separating only coupled metal fine particles with a suitable measure, and measuring a transmitted light intensity of solution in which the metal fine particles are dispersed or a substrate to which the metal fine particles are adsorbed.

This method permits sensitive detection. However, when the density of specific trace substances drop to a lower value, the influence of unevenness of particle diameter of coupled metal fine particles upon measurement cannot be ignored. For example, in the case of a gold colloidal particle of a diameter of several ten nm, it is known that a scattered light intensity is proportional to six powers of the particle diameter according to the Mie theory, and the measured transmitted light intensity is influenced by unevenness of the particle diameter than the number of particles. Accordingly, correlation between the transmitted light intensity and the density of particles reduces as the number of metal fine particles decreases.

(A Method for Counting the Number of Metal Colloidal Particles)

As described above, a method for counting directly the number of metal colloidal particles to which specific trace substances are coupled is effective for a sample wherein the content of specific trace substances is small. Even if the metal colloid includes colloidal particles whose particle diameter is smaller than a wave length of illumination light such as several ten nm, such a detection method is suitable for counting the metal colloidal particles because they can be identified one by one using a microscope. Concretely, the solution of the metal colloidal particles coupled with the specific trace substances is divorced with a suitable purifying measure and then developed on a glass substrate or in an optical cell formed of glass substrates glued to each other with a narrow gap. The developed solution is subjected to microscope observation under dark field illumination and acquired as a distribution of bright spots corresponding to the colloidal particles dispersed in the solution. As a result, respective particles can be identified and counted. In this way, in the case that it is thought how much the number of metal colloidal particles reflects to the content of the specific trace substances in the original specimen sample, a statistical error will be impossible to be ignored. However, this error can be reduced by increasing the measured number of colloidal particles by observing a plurality of different positions with respect to the inspection sample.

However, when the specific trace substances are going to be quantified by this method, particulate impurities, concretely, other biologic materials contained in an original specimen sample, impurities contaminated in a separation purification process, or inorganic or organic dirt such as glass powder or dusts fixed to a glass substrate or optical cell are often appeared in the visual field of a microscope. Such a dirt makes a light and shade contrast of a measurement sample lower because it strongly scatters illumination light or causes light and shade unevenness occur in a visual field. Also, when dirt having a diameter of several μm or less exists in a range of observed focal depth, it appears in the measured image data as a bright spot similar to the metal colloidal particle. This complicates identification of the metal colloidal particle, resulting in increasing an error occurring in counting the metal colloidal particles. The influence that these dirt give to measurement increases with a decrease in the quantity of specific trace substances, that is, the number of metal colloidal particles.

These impurities can be removed to some extent by careful separation, washing process, clean measurement environment and the appropriate handling. However, such methods are limited in cost and time. It is important for simple, high-speed, high-sensitivity detection to establish a measurement method for removing influence of these impurities.

The object of the present invention is to provide a simple, low cost metal colloid quantification method capable of detecting only metal colloidal particles in high-sensitivity even if various impurities aside from the metal colloidal particles to be quantified are appeared in an inspection visual field.

### BRIEF SUMMARY OF THE INVENTION

According to an aspect of the present invention, there is provided a method for quantifying metal colloidal particles carrying to-be-detected analytes, includes producing an inspection sample by developing solution containing the metal colloidal particles on a substrate, generating a plurality of image data about an identical visual field by enlarging and capturing the sample, removing a signal component derived from an impurity existing on the substrate from the image data by comparing the plurality of image data, and measuring the metal colloidal particles from the image data from which the signal component derived from the impurity was removed.

### BRIEF DESCRIPTION OF THE SEVERAL VIEWS OF THE DRAWING

FIG. 1 shows schematically a configuration of a quantification system implementing a method for quantifying metal colloidal particles according to a first embodiment.

FIG. 2 is a perspective view of the optical cell of FIG. 1.

FIG. 3 is a flowchart for explaining the method for quantifying the metal colloidal particles according to the first embodiment.

FIG. 4 shows schematically a configuration of a quantification system implementing the method for quantifying the metal colloidal particles according to a second embodiment.

FIG. 5 is a perspective view of the optical cell of FIG. 4.

FIG. 6 is a flowchart for explaining the method for quantifying the metal colloidal particles according to the second embodiment.

FIG. 7 shows schematically a configuration of a quantification system implementing the method for quantifying the metal colloidal particles according to a third embodiment.

FIG. 8 is a flowchart for explaining the method for quantifying the metal colloidal particles according to the third embodiment.

FIG. 9 is a view showing an image obtained by changing an exposure time in quantifying metal colloidal particles according to the third embodiment.

FIG. 10 is a view showing an image obtained by changing an exposure time with a voltage being applied to electrodes in quantifying the metal colloidal particles according to the third embodiment.

FIG. 11 shows schematically a configuration of a quantification system implementing a method for quantifying metal colloidal particles according to a fourth embodiment.

FIG. 12 is a flowchart for explaining the method for quantifying the metal colloidal particles according to the fourth embodiment.

FIG. 13 is a view showing an image obtained by changing an applied voltage in quantifying the metal colloidal particles according to the fourth and fifth embodiments.

### DETAILED DESCRIPTION OF THE INVENTION

There will be described a method for quantifying metal colloidal particles according to the first embodiment in conjunction with the accompanying drawings in detail hereinafter.

Before description of the first embodiment, a principle of a metal colloid quantification method according to this embodiment will be explained.

When metal colloidal solution is developed on a glass substrate or injected in a glass optical cell, it is known that, for example, some metal colloidal particles are negatively charged. The state that the colloidal particles drift while doing an irregular Brownian motion in the liquid without adhering to the substrate in room temperature can be observed with a dark-field microscope. The colloidal particles doing such a motion are left in image data as bright spots in the case of a short exposure time. However, when they are captured with a sufficiently long exposure time, a trace of motion of colloidal particles is provided as image data. In this time, since the colloidal particles move, the trace of motion of the colloidal particles does not lighten even if an exposure time is increased and does nothing but extend in irregular.

On one hand, the impurities existing on the substrate, for example, glass powder of a diameter of several μm or less are appeared as bright spots similar to the metal colloidal particles when they are observed with a dark-field microscope. Although these impurities have a sufficiently small size, they may be not distinguished from the metal colloidal particles in size of the bright spot. However, since these impurities are fixedly adhered to the substrate, the trace of impurities is not appeared even if the exposure time is increased. It is confirmed that the brightness of the bright spot increases in proportion to the exposure time. Accordingly, if a plurality of image data are acquired by changing a measurement condition without changing an inspection visual field of a microscope, it can be identified whether the bright spot of the data is a colloidal particle or an impurity existing on the substrate.

There will be described the method for quantifying the metal colloidal particles according to the first embodiment referring to FIGS. 1 to 3.

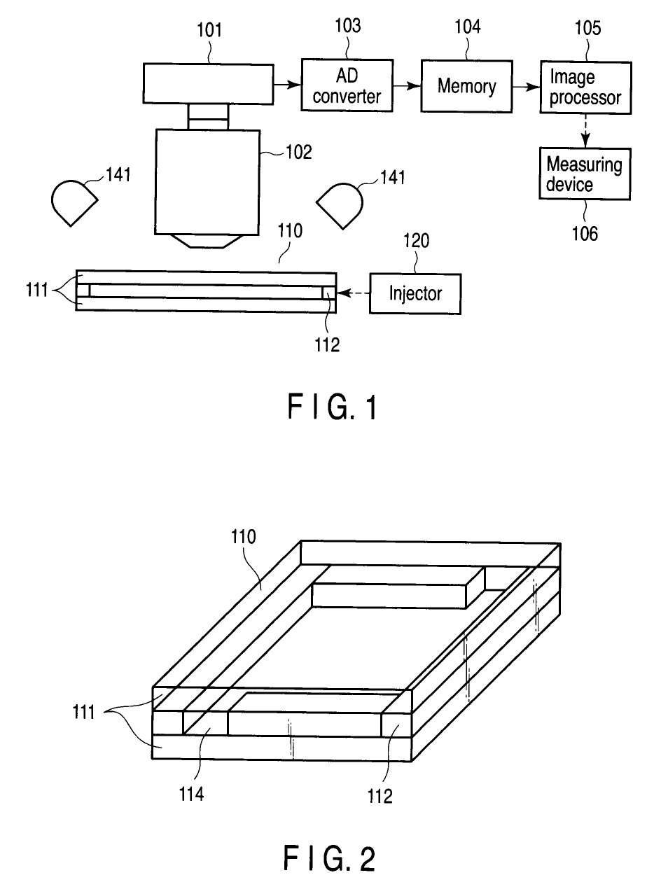

A quantification system implementing the metal colloid quantification method according to the first embodiment is shown in FIG. 1. According to this, a camera 101 is mounted on a microscope 102. This microscope 102 faces an optical cell 110 fabricated by processing the substrate for observing a sample made by developing solution including metal colloid. This optical cell 110 comprises a thin optical cell fabricated by two substrates laminated to each other and suitable spacers such as glass beams inserted between the substrates. The periphery of the laminated substrates is sealed with resin and the like. In other words, the optical cell 110 is fabricated by a pair of rectangular transparent substrates 111 arranged facing to each other as shown in FIG. 2 and spacers 112 inserted between the peripheral portions of the transparent substrates 111.

Transparent substrates 111 may be formed of various glass materials which are optically transparent from visible light to near infrared rays and excellent in stability such as soda-lime glass, borosilicate glass, quartz glass, or resin materials which are optically transparent and excellent at workability and chemical resistance such as acrylic resin, polycarbonate, polypropylene, polydimethylsiloxane (PDMS) and the like. The spacers 112 each are formed of seal resin pieces 112a provided on the opposite sides of the rectangular transparent substrates 111 and seal resin pieces 112b provided on the other opposite sides thereof. The seal resin pieces 112b each have one end contacting with the end of the seal resin piece 112a and are shorter than the seal resin piece 112a. The space formed between the edges of the seal resin pieces 112a and 112b is used as an inlet 114 for the metal colloidal solution. The metal colloidal solution is injected with an injector 120 through this inlet 114.

The optical cell 110 can use a micro flow chip on which a minute passage and a reservoir are formed on a substrate made of glass materials or resin materials. In this specification, the wording “substrate” is assumed to means such an optical cell or a flow chip. Solution is injected in the optical cell or the flow chip to develop metal colloidal solution on the substrate. It is preferable that the gap of the optical cell or the passage depth of the flow chip is substantially identical to the focal depth of an optical enlarger or less. It is preferable that the passage depth is 100 μm or less concretely. Further, an optical microscope is used to enlarge optically the sample which solution including metal colloidal particles is developed on the substrate. It is more preferable that a dark-field microscope can be used.

The metal colloidal particles are preferably made of materials in a range from 10 nm to 1 μm in diameter. The metal colloidal particles are preferably made of metals having a plasmon resonance property in a wavelength range from visible light to near infrared rays such as gold or silver. For a more detailed structure of the fine particles, fine particles of these metal simple substances or complex substances, or fine particles having the structure that these metal simple substances or complex substances are coated on other materials such as resin beads can be used.

The camera 101 uses preferably a camera having sensitivity to wave length light from visible light to a near infrared region for a plurality of image signals to be acquired. It may use a CCD camera or a CMOS image sensor. The camera 101 is connected to a memory 104 through an AD converter 103 which converts an image signal to digital data. The memory 104 stores digital image data as an electronic file. An image processor 105 is connected to the memory 104 to read the digital image data from the memory 104 and subjects the image data to comparison operation. A measuring device 106 counts the number of metal colloidal particles based on the image data processed with the image processor 105.

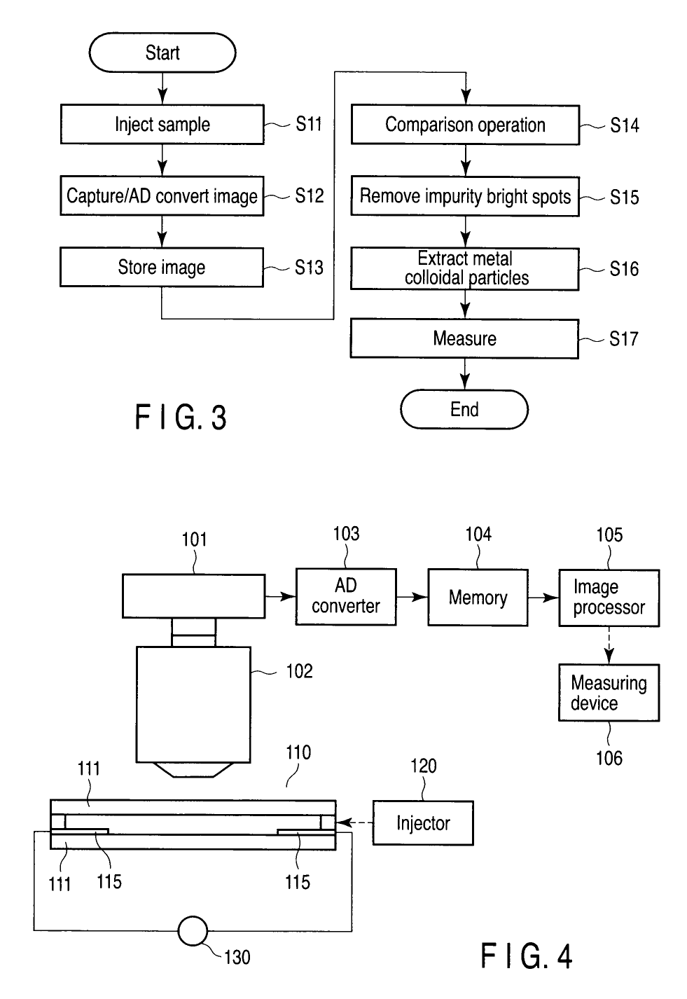

The metal colloid quantification method according to the first embodiment to be implemented using the quantification system of FIG. 1 will be described referring to flowchart of FIG. 3.

At first, solution containing the metal colloid carrying to-be-detected analytes is poured in the optical cell 110 from the inlet 114 of the optical cell 110 with the injector 120 to develop the solution on the glass substrate 11 and prepare an inspection sample (S11). The inspection sample is subjected to dark field illumination with an illuminator 141 and enlarged optically with the microscope 102 and captured with the camera 101 several times to generate a plurality of image signals corresponding to a plurality of images (about an identical visual field). The image signals are converted into a plurality of digital image data with the AD converter 103 (S12). These image data are stored in the memory 104 sequentially (S13).

The digital image data of the memory 104 are read with the image processor 105, and subjected to comparison operation with the image processor 105. The signal components (data components) derived from the metal colloidal particles are distinguished from the signal components (data components) derived from the bright spots of the impurities existing on the transparent substrate 111 by the comparison operation (S14). In this case, the metal colloidal particles are distinguished from the impurities based on motion of the bright spots due to the conduction that the impurities are fixed whereas the metal colloidal particles move. The data components derived from the bright spots of the impurities existing on the transparent substrate 111 are removed from the image data based on the distinguished result (S15) to extract the metal colloidal particles (S16). The extracted metal colloidal particles are counted (S17). In other words, the number of metal colloidal particles is counted based on the data component of the metal colloidal particles.

In order for the number of metal colloidal particles to be counted from the metal colloid data component, image analysis/processing software which allows the measuring device to extract the number of bright spots contained in the image data and corresponding to the metal colloidal particles with a predetermined condition and count them has only to be used. For example, Image-ProPlus™ (Nippon Roper Company) may be used. Alternatively, the measurement of metal colloidal particles may be done by displaying processed image data on a display and counting the bright spots corresponding to the metal colloidal particles, which are displayed on the display.

The second embodiment is explained referring to FIGS. 4 to 6. In the second embodiment, like reference numerals are used to designate like structural elements corresponding to those like in the first embodiment and any further explanation is omitted for brevity's sake.

In the metal colloid quantification method according to the second embodiment, a pair of electrodes 115 are provided on the optical cell 110 of the quantification system implementing the metal colloid quantification method of the first embodiment. A plurality of image data are acquired in the state that a given voltage is applied to the pair of electrodes from a voltage source 130.

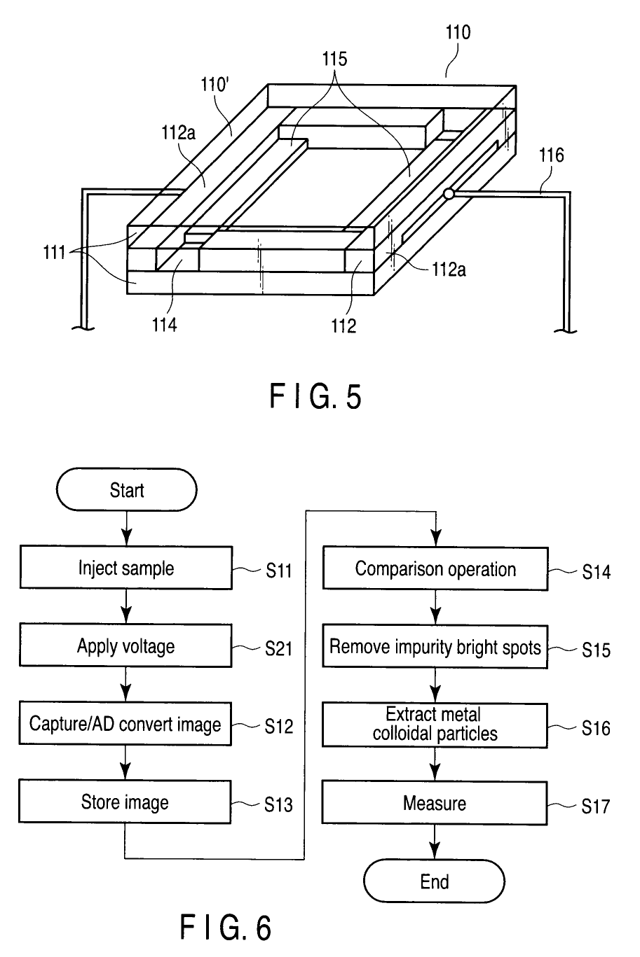

The pair of electrodes 115 are preferably made of materials not corroded by solution including the metal colloidal particles, for example, inert metals such as platinum or conductive transparent materials such as ITO. The pair of electrodes 115 are formed on the substrate 111 by an evaporation method or sputtering method. In the case of the optical cell, the electrodes are formed at the position where they can be in contact with the colloidal solution in the cell, and a lead wire for applying a voltage to the colloidal solution from outside is provided from the electrodes to the substrate 111 or the outside of the cell as shown in FIG. 5, for example. In other words, the pair of electrodes 115 are formed in a form of rectangle, and penetrate through the opposed seal resin pieces 112a, respectively. The electrodes 115 are led to the outside with the lead wire 116.

It is preferable that a distance between the pair of electrodes is larger than the long side of the visual field of the optical microscope such that the electrodes are out of the visual field. Further, the voltage to be applied to the pair of electrodes 115 is set to a value such that the electrophoretic migration of the metal colloidal particles in the solution can be recorded in a plurality of image data distinctly and distinguished definitely from dirt and the like which are not be subjected to electrophoretic migration. It is desirable that a suitable potential gradient occurs in the solution between the electrodes for the metal colloidal particles to migrate in the electrophoresis. Therefore, a suitable electrolyte may be added to the colloidal solution. In this time, the kind and addition volume of electrolyte are regulated so that the metal colloid does not cause coagulating sedimentation by the added electrolyte.

The metal colloid quantification method according to the second embodiment implemented using the quantification system of FIG. 4 will be described referring to flowchart of FIG. 6. Solution containing metal colloid is injected to the optical cell 110 (S11), and then a given voltage is applied to the pair of electrodes 115 with the voltage source 130 (S21). In this time, the metal colloidal particles subjected to electrophoretic migration in the solution are enlarged with the microscope 102 and captured with the camera 101 several times to generate a plurality of image signals corresponding to a plurality of images (S12). The image signals provided by the camera 101 are AD-converted to obtain a plurality of image data. The image data are stored in the memory 104 (S13). Comparison operation is performed on the image data (S14) and impurity bright spot data component is removed from the image data (S15). In this case, the metal colloidal particles subjected to electrophoretic migration in the solution by application of a voltage to the electrodes are distinguished from the dirt and the like which are not subjected to electrophoretic migration based on the image data definitely, whereby the impurity bright spot data component can be removed. Thereafter, the metal colloidal particles are extracted (S16), and the extracted metal colloidal particles are measured (S17).

According to the second embodiment, since the metal colloidal particles are subjected to electrophoretic migration by applying a voltage to the electrodes formed on the optical cell, the metal colloidal particles can be distinguished from the dirt based on the image data definitely.

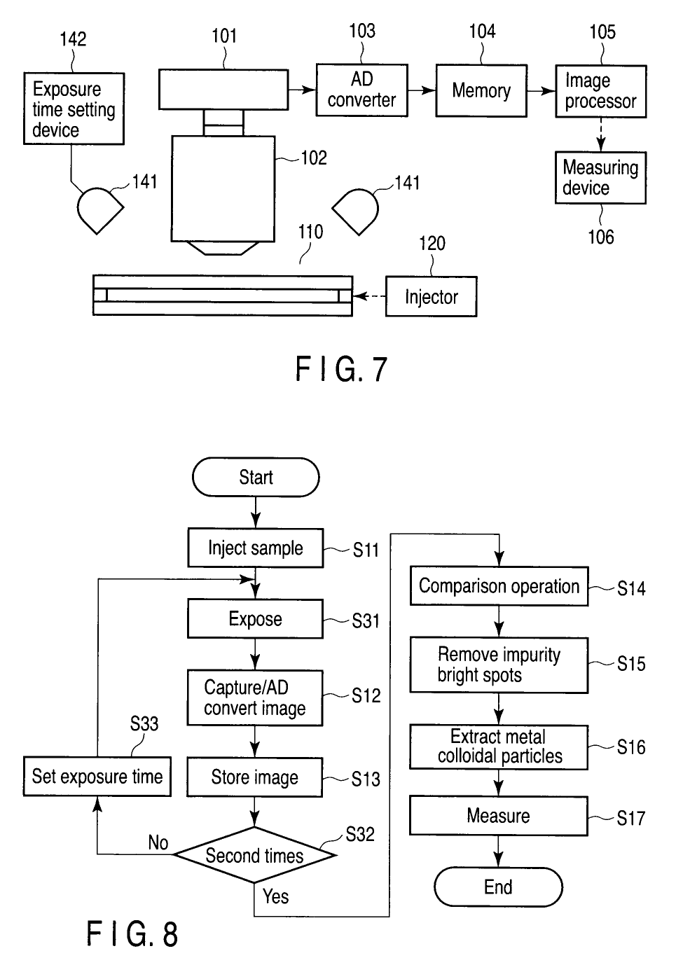

The third embodiment is explained referring to FIGS. 7 to 10. In the third embodiment, like reference numerals are used to designate like structural elements corresponding to those like in the first and second embodiments and any further explanation is omitted for brevity's sake.

The metal colloid quantification method according to the third embodiment further includes measuring the metal colloidal particles based on the image data obtained by capturing the sample by changing an exposure time. In other words, an exposure time setting device 142 is connected to illuminators 141 subjecting the optical cell 110 to dark field illumination, that is, lighting obliquely upward on the optical cell as shown in FIG. 7. First image data is acquired by capturing a given visual field of solution for a first exposure time, and second image data is acquired by capturing substantially the same visual field as the given visual field for a second exposure time longer than the first exposure time. The quantification of metal colloidal particles is done using the image data of different exposure times. In addition, the exposure time setting device 142 may be connected to the camera 101 to open the shutter of the camera for a predetermined exposure time.

The first exposure time for acquiring first image data is preferably set to a time period during which the metal colloid is not substantially subjected to electrophoretic migration. More concretely, the exposure time is preferably set to a time period during which the moving distance of the metal colloid is not more than optical spatial resolution, for example, 1 μm or less. Further, the second exposure time for the acquisition of the second image data is preferably set to a time period which is longer than the first exposure time, and which can confirm a motion trace of the metal colloid in the second image data definitely. The metal colloid quantification method according to the third embodiment using the quantification system of FIG. 7 will be described referring to flowchart of FIG. 8. Solution containing metal colloid is injected to the optical cell 110 (S11), and then a first exposure time is set with the exposure time setting device 142 and solution of the optical cell 110 is exposed only during the first time period with the illuminators 141 (S31). In this time, the image enlarged with the microscope 102 is captured with the camera 101 to acquire a first image signal (S12). The first image signal is AD-converted similarly to the above embodiments and stored in the memory 104 (S13).

Subsequently, it is determined whether it is the second exposure (S32). Because this determination is NO, the second exposure time longer than the first exposure time is set with the exposure time setting device 142 (S33). The solution is again exposed during only this second exposure time with the illuminators 141 (S31), and captured to acquire a second image signal (S12). The second image signal is AD-converted and stored in the memory 104 (S13). The first image data and second image data which are stored in the memory 104 are compared with each other (S14). The data component derived from impurity bright spots is removed from image data based on a comparison result (S15). In other words, the first image data corresponds to the captured image of the first exposure time set to a time period during which the metal colloidal particle does not move substantially, and the second image data corresponds to the captured image of the second exposure time set to a time period during which motion of the metal colloidal particle can be confirmed. Accordingly, the trace that the metal colloidal particle moved can be confirmed in the second image data definitely. As a result, the data component derived from the impurity bright spot can be removed from the image data. Thereafter, the metal colloidal particles are extracted (S16) and the extracted particles are counted (S17).

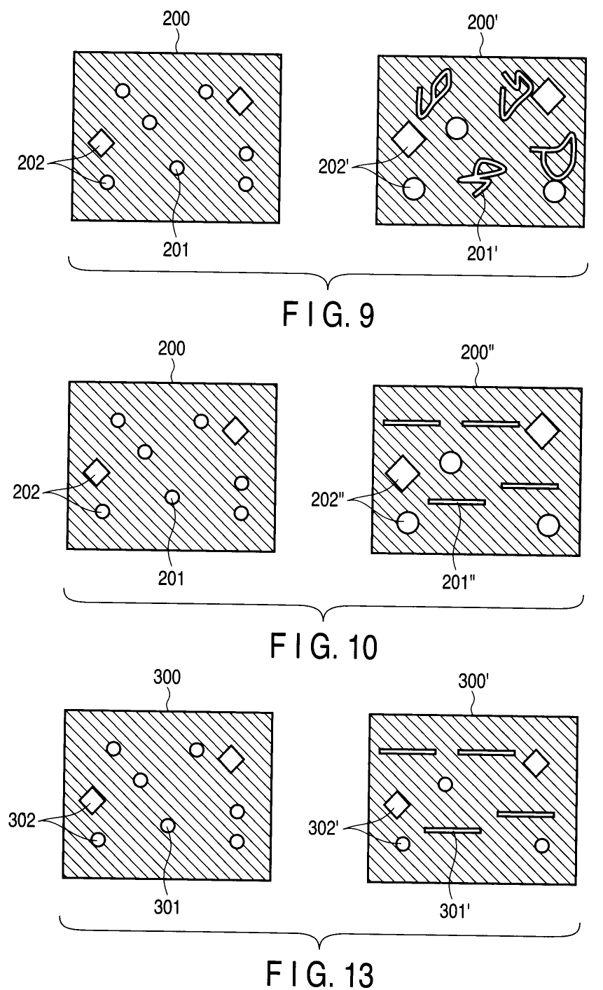

Concretely, the first image data (200) shown in FIG. 9 is acquired by capturing a given visual field of colloidal solution for the first exposure time. The exposure time in this capturing is set to a time period during which the bright spots 201 of the metal colloidal particles are generated in the image 200.

Subsequently, the visual field substantially identical to the given visual field is captured for the second exposure time longer than the first exposure time to acquire the second image data (200′). The exposure time in capturing the image 200′ is set to such a time that the luminance of the bright spot corresponding to the impurity existing in the substrate indicates a significant difference between the bright spot 202 of the first image 200 and the bright spot 202′ of the image 200′.

In order for the signal derived from the impurity bright spot to be removed from the images 200 and 200′ acquired in this way, the bright spots which the position change is smaller than a certain setting value are compared with each other about the image 200 and the image 200′, it is determined the bright spot at which the increasing rate of brightness in the second image 200′ with respect to the first image 200 is larger than a predetermined threshold is a data component derived from the impurity bright spot, and the data component derived from the impurity bright spot is removed from the first image data using position information of the signal. The image processing for removing the data component derived from the impurity bright spot from the first image 200 is implemented by software. The number of metal colloidal particles is measured by counting the number of bright spots included in the image 200 subjected to this image processing using a given brightness and an area of the bright spot as a threshold.

As described in the second embodiment, a pair of electrodes are formed on a substrate beforehand, and a given voltage can be applied to the electrodes when the solution containing metal colloidal particles is developed on the substrate so as to be in contact with the electrodes, and this sample, i.e., developed solution is enlarged optically and captured to generate image signals. When this method is used, for example, negatively charged metal colloidal particles can be subjected to electrophoretic migration on the high electric potential side by a potential gradient between the electrodes. Accordingly, when a plurality of image data are acquired by changing the exposure time as described in the third embodiment, a trace of motion of the metal colloidal particle in the image data (200″) is nearly linear as shown in FIG. 10, for example. It is possible to discriminate between the metal colloidal particle and the impurity existing in the substrate clearly in comparison with a random trace by a Brownian motion. According to the method, even if the impurity is an impurity not fixed to the substrate, if it differs in charging characteristics and mass from the metal colloid, such an impurity can be discriminated from the metal colloidal particle because the length and direction of the trace of motion differ from the colloidal particles.

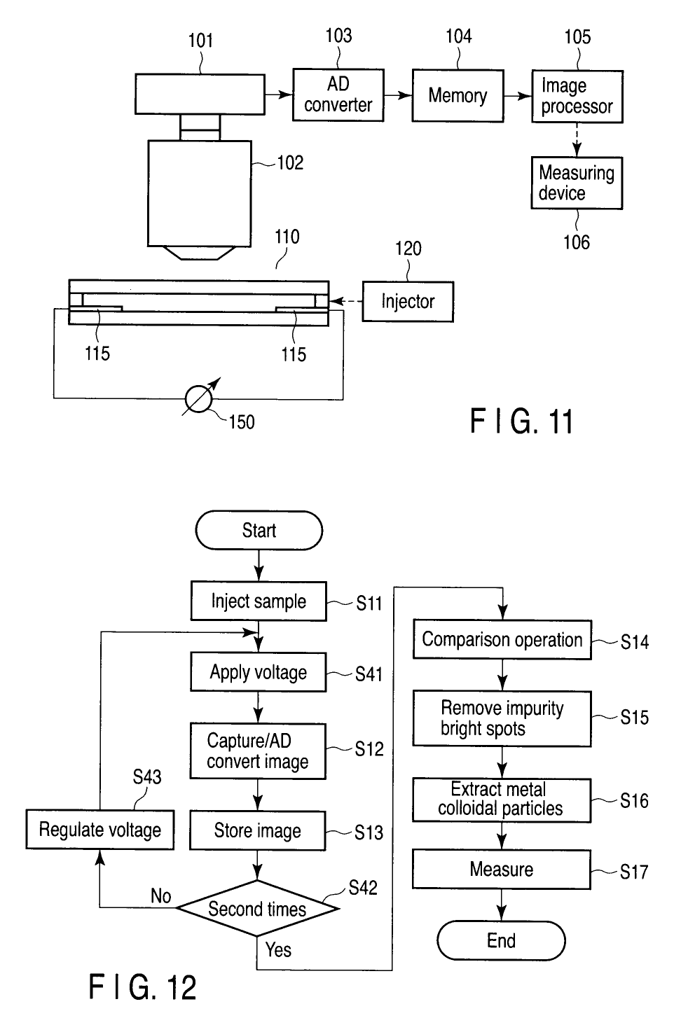

The fourth embodiment is explained referring to FIGS. 11 to 13. In the fourth embodiment, like reference numerals are used to designate like structural elements corresponding to those like in the second embodiment and any further explanation is omitted for brevity's sake.

The metal colloid quantification method according to the fourth embodiment acquires first and second image data by changing the voltage to be applied to a pair of electrodes 115. In other words, a first voltage is applied to the pair of electrodes 115, and a given visual field of solution is captured to acquire first image data, and a second voltage higher than the first voltage in absolute value is applied to the pair of electrodes 115 and a visual field substantially identical to the given visual field is captured to acquire second image data. In other words, in the fourth embodiment, the voltage source of the second embodiment is replaced with a variable voltage source 150.

The materials of the pair of electrodes concerning the present embodiment, the method for forming them, and the position at which they are formed follow the pair of electrodes concerning the second embodiment. The first voltage for acquisition of the first image data is preferably a voltage by which the metal colloidal particle is not migrated substantially in the first image data obtained by a given exposure time. More concretely, the voltage is preferably set to a value by which the moving distance of the metal colloid is not more than optical spatial resolution, for example, 1 μm or less. It is preferably 0V.

The second voltage for acquisition of the second image data is preferably a voltage which is larger than the first voltage in absolute value so as to subject the metal colloidal particle to electrophoretic migration and by which the moving trace of the metal colloidal particle can be confirmed definitely in the second image data obtained for a given exposure time.

The metal colloid quantification method according to the fourth embodiment using the quantification system of FIG. 11 will be described referring to flowchart of FIG. 12. Solution containing metal colloid is injected to the optical cell 110 (S11), and then the first voltage is applied to the pair of electrodes 115 with a voltage regulator 150 (S41). In this time, the image enlarged with the microscope 102 is captured with the camera 101 to acquire a first image signal (S12). The first image signal is AD-converted similarly to the above embodiments and stored in the memory 104 (S13).

Subsequently, it is determined whether it is the second capturing (S42). Because this determination is NO, the second voltage is set with the voltage regulator 150 (S43). This second voltage is applied to the pair of electrodes (S41), the capturing is done (S12) to acquire the second image signal. This second image signal is AD-converted and stored in the memory 104 (S13). The first image data and second image data stored in the memory 104 are compared with each other (S14). The data component derived from the impurity bright spot is removed based on a comparison result (S15). In other words, the first image data corresponds to the captured image of the first voltage set to a value by which the metal colloid does not move substantially, and the second image data corresponds to the captured image of the second voltage set to a value by which motion of the metal colloidal particle can be confirmed. Accordingly, the trace that the metal colloidal particle moved can be confirmed in the second image data definitely. As a result, the data component derived from the impurity bright spot can be removed. Thereafter, the metal colloidal particles are extracted (S16) and the extracted particles are counted (S17).

In the metal colloid quantification method concerning the fifth embodiment, when the sample is enlarged optically and captured to acquire a plurality of image signals in the metal colloid quantification method of the fourth embodiment, the exposure time is substantially equalized between acquisition of the first image signal and acquisition of the second image signal. In the fourth embodiment, at first the first voltage is applied to the pair of electrodes, and a given visual field of solution is captured for a given exposure time to acquire the first image signal (image 300 of FIG. 13). Next, the second voltage higher than the first voltage in absolute value is applied to the pair of electrodes, and the visual field substantially identical to the given visual field is captured for the exposure time substantially equal to the given exposure time to acquire the second image signal (300′). In this way, if the exposure times for the image signals 300 and 300′ are equalized, the component fixed to the substrate does not change in brightness, shape and position between the captured images 300 and 300′. Accordingly, if a difference between the first image data and the second image data is calculated, the data component derived from the impurity existing on the substrate can be removed from the first and second image data.

In the metal colloid quantification method concerning the sixth embodiment, the metal colloid is chemically modified so as to have charging characteristics of the same sign as the substrate in order to prevent the metal colloidal particles from being fixed to the substrate. It will be appreciated that this process can be applied to any one of the first to fifth embodiments. The materials chemically-modifying the metal colloid have only to use chemical modifiers having on one side a functional group I capable of chemically binding to the metal colloidal particle surface such as thiol group or sulfide group and on the other side a functional group II indicating a charge state of the same sign as the surface charge state of the substrate. For example, when the substrate is charged in negative such as quartz glasses, there are but not limited to, a carboxyl group, a hydroxyl group, sulfonic acid radix for the functional group II.

In the metal colloid quantification method concerning the seventh embodiment, the substrate is subjected to chemical modification or water-repellent process so as to have charging characteristics of the same sign as the metal colloid in order to prevent the metal colloidal particles from being fixed to the substrate. The materials for subjecting the substrate to chemical modification have only to use coating materials having the functional group such as a carboxyl group, a hydroxyl group, a sulfonic acid ground when the substrate is made by resin, and the metal colloid is charged in negative. A fluorine system silane coupling agent and the like may be used for subjecting the substrate to the water-repellent process.

According to the metal colloid quantification method explained above, even if the metal colloidal particles are developed on the substrate, they are maintained so as to be not fixed to the substrate, a trace of the metal colloidal particle that is formed by a Brownian motion or electrophoretic migration by application of a voltage can be acquired as image data, and the metal colloidal particles moving in the solution can be discriminated from the impurity existing on the substrate by changing an applied voltage and an exposure time. Accordingly, the colloidal particles can be quantified by counting the colloidal particles even if the colloidal solution density is very small.

According to the method, metal colloidal particles are coupled to specific trace substances concerning disease selectively, the coupled colloidal particles are separated, and then the metal colloidal particles are quantified according to the present metal colloid quantification method. Accordingly, even if a sample is materials of very low density, quantification can be implemented.

The metal colloid quantification method concerning the present invention is not limited to only the detection of specific trace substances concerning disease, and applicable to various fields such as a field for detecting environmental endocrine disrupter by subjecting the metal colloid to appropriate chemical modification because the chemical compound to be detected have only to be coupled to the metal colloidal particles selectively.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for quantifying metal colloidal particles carrying to-be-detected analytes, comprising:
producing an inspection sample by developing solution containing the metal colloidal particles on a substrate;
generating a plurality of image data about an identical visual field by enlarging and capturing the sample;
removing a signal component derived from an impurity existing on the substrate from the image data by comparing the plurality of image data; and
measuring the metal colloidal particles from the image data from which the signal component derived from the impurity was removed.

2. The method according to claim 1, wherein the generating the plurality of image data includes capturing a given visual field of the sample for a first exposure time to generate first image data; and capturing a visual field of the sample that is substantially identical to the given visual field for a second exposure time longer than the first exposure time to generate second image data.

3. The method according to claim 1, wherein the metal colloidal particles are subjected to chemical modification to have charging characteristics of a sign identical to that of the substrate in order to prevent the metal colloidal particles from being fixed to the substrate.

4. The method according to claim 1, wherein the substrate is subjected to chemical modification or water-repellent process to have charging characteristics of a sign identical to that of the metal colloidal particles in order to prevent the metal colloidal particles from being fixed to the substrate.

5. The method according to claim 1, wherein the producing the inspection sample includes forming a pair of electrodes on the substrate; and developing the solution on the substance with the pair of electrodes being in contact with the solution containing the metal colloidal particles, and
the generating the plurality of image data includes acquiring the plurality of image data by capturing the sample with a given voltage applied to the pair of electrodes.

6. The method according to claim 5, wherein the metal colloids are subjected to chemical modification to have charging characteristics of a sign identical to that of the substrate in order to prevent the metal colloidal particles from being fixed to the substrate.

7. The method according to claim 5, wherein the substrate is subjected to chemical modification or water-repellent process to have charging characteristics of a sign identical to that of the metal colloidal particles in order to prevent the metal colloidal particles from being fixed to the substrate.

8. The method according to claim 5, wherein the generating the plurality of image data includes capturing a given visual field of the sample for a first exposure time to generate first image data; and capturing a visual field of the sample that is substantially identical to the given visual field for a second exposure time longer than the first exposure time to generate second image data.

9. The method according to claim 8, wherein the removing the signal component includes determining as a signal component derived from the impurity a signal indicating that an increase rate of brightness in the second image data to that in the first image data is not less than a given threshold; and removing a data component derived from the impurity from the first image data using position information of the signal component.

10. The method according to claim 1, wherein the producing the inspection sample includes forming a pair of electrodes on a substrate; and developing the solution on the substrate with the pair of electrodes being in contact with the solution containing the metal colloidal particles, and
the generating the plurality of image data includes capturing a given visual field of the sample with a first voltage being applied to the pair of electrodes to generate first image data; and capturing a visual field substantially identical to the given visual field with a second voltage larger than the first voltage in absolution value being applied to the pair of electrodes to generate second image data.

11. The method according to claim 10, wherein the generating the plurality of image data generates the first image data and the second image data for a substantially identical exposure time, and the removing the signal component includes calculating a difference between the first image data and the second image data; and removing a substantially equal signal component between the first image data and the second image data.

12. The method according to claim 10, wherein the metal colloidal particles are subjected to chemical modification to have charging characteristics of a sign identical to that of the substrate in order to prevent the metal colloidal particles from being fixed to the substrate.

13. The method according to claim 10, wherein the substrate is subjected to chemical modification or water-repellent process to have charging characteristics of a sign identical to that of the metal colloidal particles in order to prevent the metal colloidal particles from being fixed to the substrate.
